(19) United States
(12) Patent Application Publication
(10) Pub. No.: US 2010/0025432 A9
(43) Pub. Date: Feb. 4, 2010

(54) WRISTBAND-MOUNTED DISPENSER FOR LIQUIDS AND POWDERS WITH AN IMPROVED DISPENSING MECHANISM

(75) Inventors: John Yapaola, Kinnelon, NJ (US); David Conroy, Brooklyn, NY (US)

Correspondence Address: GORDON E NELSON;PATENT ATTORNEY, PC, 57 CENTRAL ST, PO BOX 782, ROWLEY, MA, 01969, US

(73) Assignee: Pwristine, Inc., Kinnelon, NJ (US)

(21) Appl. No.: 12/128,311

(22) Filed: May 28, 2008

Related U.S. Application Data
(63) Continuation-in-part of application No. 12/066,543, filed on Mar. 12, 2008.
(60) Provisional application No. 60/940,438, filed on May 28, 2007.

(51) Int. Cl. B67D 7/84; B65D 88/54; B67D 7/58

(52) U.S. Cl. 222/175; 222/383.1; 222/372; 222/340; 222/341

(57) ABSTRACT

An apparatus for dispensing material includes: a chamber for the material, the chamber sealed by a flexible seal; a nozzle coupled to the chamber and residing at a front end; and a pump, the pump comprising: a piston that moves in a tube, and an activator. When a user presses the activator, the piston moves toward or away from the front end, and a portion of the material is emitted onto the user's palm or fingers. The pump emits the portion of the material regardless of a direction of gravitational pull. In one embodiment, the piston emits the material by directly contacting the material in the chamber. In another embodiment, air is allowed into the chamber through a weep hole, which resides between the piston and the material. The air is used to expel the material through the one-way valve.

### CROSS-REFERENCE TO RELATED APPLICATIONS

This application claims priority to co-pending U.S. provisional patent application entitled “Wristband-mounted dispenser for liquids and powders with an improved dispensing mechanism”, Ser. No. 60/940,438, filed on May 28, 2007. This application is further a continuation-in-part of co-pending international application entitled “Wristband-mounted dispenser for liquids and powders”, international application no. PCT/US2006/035681, with an international filing date of 14 Sep. 2006. Both of these applications are hereby incorporated into the present patent application by reference for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates to dispensers of liquids and powders and more particularly to such dispensers that dispense the liquid or powder in discrete amounts.

2. Description of Related Art

There are many situations in which it is desirable to frequently apply a topical lotion or powder by hand. One example is the application of lotions or germicidal solutions to the hands; another is the application of sunblock or suntan lotion; a third is the application of insect repellant. Frequent application is often made more difficult by the fact that the need to apply occurs in an environment such as work or the beach where it may be inconvenient to get to a bottle of the lotion or powder. A disclosure of one approach to solving the problem of having a solution or powder available when you need it could be found on Apr. 14, 2006 at www.wristbands.com.au/sun-screen-wristbands.htm. The sun screen wristband disclosed there is a tube containing 50 mL of sunscreen. The tube is closed with a cap and has the form of a bracelet that can be worn on the wrist or arm. To apply the sunscreen, one removes the bracelet from the arm and then applies sunscreen as one does from an ordinary tube of sunscreen: one opens the cap, uses one hand to squeeze the sunscreen out of the tube into the palm of the other hand, and then applies the sunscreen. While this approach is useful for applying sunscreen, which need be done only every two hours or so, it has a number of practical and aesthetic drawbacks:
The process of application, which involves removing the bracelet, opening the cap, and squeezing out the sunblock, is too time consuming for use with substances such as germicides, which must be applied at far more frequent intervals;
The bracelet has no mechanism for providing measured amounts of sunblock.
The bracelet is not refillable;
The bracelet is too bulky and conspicuous to be worn with ordinary white- or pink-collar work clothes.

What is needed is a wristband that dispenses a material, but is easier to use, provides measured amounts of the material, is refillable, and may be worn with ordinary white- or pink-collar work clothes. It is an object of the present invention to provide such a wristband.

### BRIEF SUMMARY OF THE INVENTION

The object of the invention is achieved by a bracelet that has attached to it a dispenser for dispensing a material. The dispenser has a space for the material, a nozzle, and an activator and responds to pressure of a finger on the activator by emitting a portion of the material in the space through the nozzle. Further aspects of the invention include the following:
the bracelet is worn on the wrist with the dispenser on the palm side of the wrist and the nozzle is situated on the dispenser such that the emitted material is directed towards the palm of the hand attached to the wrist.
the dispenser is aimable. One way of aiming the dispenser is by flexing the bracelet.
the space may be refilled with the material.
the material is contained in a container and the space is refilled by placing some of the material in the container within the space or by placing the container in the space.
the material may be a liquid or a powder and may have germicidal or sunblocking properties.
the dispenser comprises a pump that responds to the pressure of a finger on the activator by pumping material from the space through the nozzle. The pump is not affected by the orientation of the dispenser.
The dispense is approximately the size of the watch in a wristwatch and the bracelet may additionally be used in any way in which a bracelet has been or will be used.

The pump used in an embodiment of the dispenser has a piston that moves in a tube. The tube has an end and a first one-way valve in a wall of the tube. The one-way valve admits air to the tube but blocks air from escaping from the tube. The pump further has an air-tight chamber which is connected to the end of the tube and is capable of being connected by a second one-way valve to a source of the material. The second one-way valve opens only when the pressure in the chamber is lower than the pressure on the material in the source of material, The air-tight chamber is further connected to a third one-way valve that opens only when the pressure in the chamber is higher than the pressure on the other side of the valve. Operation of the pump when the source of material is connected to the chamber is as follows: when the piston is moved away from the end of the tube, the pressure in the chamber is decreased and as a result, a portion of the material moves from the source through the second one-way valve into the chamber until the piston passes the first one-way valve. When the piston is then moved back toward the end of the tube, the pressure in the tube is increased and as a result, material in the chamber moves through the third one-way valve.

In other aspects, the amount of material that moves from the source into the chamber depends on the position of the first one-way valve relative to the end of the tube and the amount by which the pressure in the chamber is increased depends on the distance between a start position for the piston in the tube and the end of the tube.

The pump of the embodiment includes a one way valve that is made up of a flexible diaphragm and a support on one side of the diaphragm. The flexible diaphragm is situated between spaces that may be at different pressures. The diaphragm has an opening which is closed when the diaphragm is flat and which opens increasingly as the diaphragm flexes in response to a difference between the pressures. The support permits the diaphragm to flex towards one of the spaces but not towards the other.

### BRIEF DESCRIPTION OF THE SEVERAL VIEWS OF THE DRAWINGS

FIG. 1 is a view of one embodiment of a wristband with a dispenser for materials;

FIG. 2 is a set of detailed views of an embodiment of a dispenser that may be used in the wristband of FIG. 1;

FIG. 3 is a set of views of another embodiment of a dispenser that may be used with the wristband of FIG. 1;

FIG. 4 presents exploded and cross-sectional views of the dispenser of FIG. 3;

FIG. 5 is a detailed view of an embodiment of a one-way spit valve;

FIG. 6 provides views of a first improved version of the wrist-mounted dispenser;

FIG. 7 provides views of a second improved version of the wrist-mounted dispenser;

FIG. 8 is a detailed view of the plunger, the plunger activator, and the plunger diaphragm in an embodiment;

FIG. 9 is a detailed view of the channel piece 709 in which passage 631 is formed in an embodiment; and

FIG. 10 is a detailed view of the front piece, the channel piece, the spit valve, and the valve backer in an embodiment.

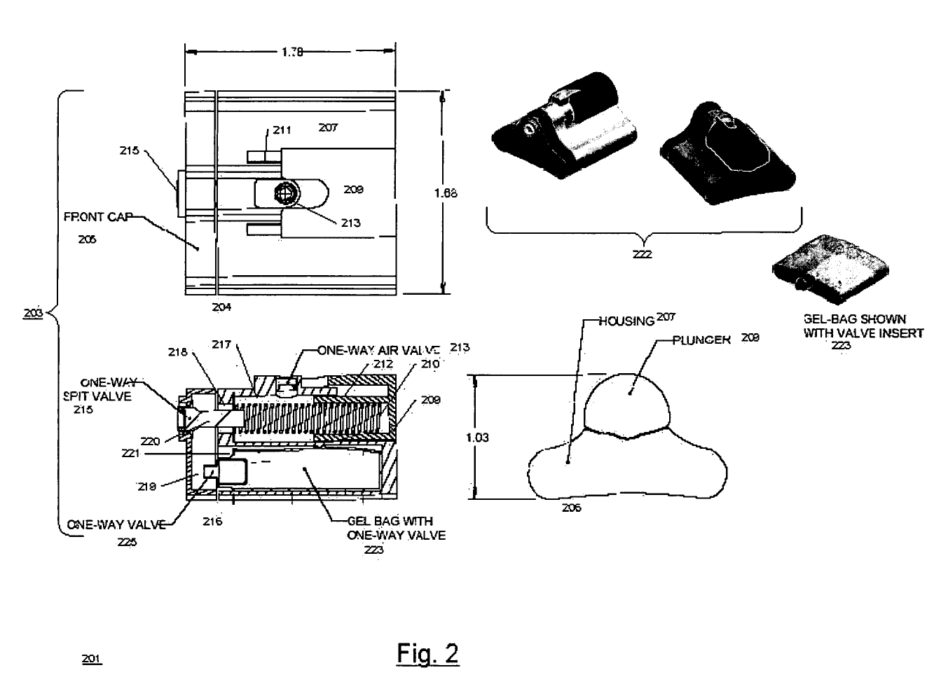

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

Overview of the Invention

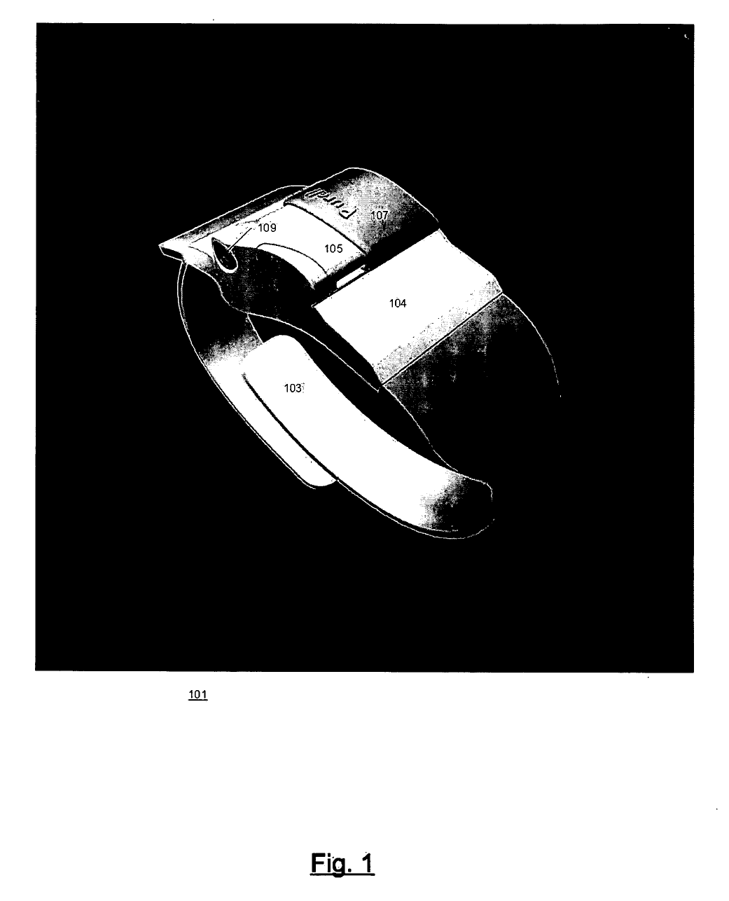

FIG. 1 provides an external view of a dispenser bracelet 101 that dispenses liquids or powders. Dispenser bracelet 101 includes a wrist band 103 so that it can be worn like a wrist watch. Mounted on wristband 103 is a dispenser 104 that contains a tank of the material (not shown), a pump 105, and a piston 107. Dispenser 104 is approximately the size of a large wristwatch. To activate the dispenser bracelet, the user presses piston 107 while wearing the bracelet. When the user does so, a small amount of the material being dispensed spurts from spit valve 109. The user wears bracelet 101 on the bottom side of his or her wrist with the spit valve facing the palm of the user's hand. When the user presses the piston with a finger of his or her other hand, the material is deposited on the palm or fingers of the hand whose wrist bears dispenser bracelet 101. The user can then spread the material as desired. Dispenser bracelet 101 can be either of a disposable or re-fillable type and can be a single compartment or a multiple compartment dispenser, storing different amounts and kinds of materials. Among the materials that can be dispensed using dispenser 101 are disinfectant hand cleaning liquids, suntan lotion, sun block, perfume, or insect repellant, to name just a few of the possibilities.

Different embodiments of bracelet 101 can dispense a material in a continuous stream or predefined fixed amount. The bracelet dispenses the material in response to pressure on an activator (here piston 107) from the user's finger. The activator may also be a push-sensitive trigger or a rotating wheel trigger. In a particularly simple embodiment of the invention, the dispenser portion of the bracelet may be a reservoir which is made of flexible plastic and has a nozzle that opens only when the pressure inside the reservoir is higher than the pressure outside. In such an embodiment, the activator is the wall of the reservoir and the user activates the dispenser simply by pressing on or squeezing the wall of the reservoir. In some embodiments, the wristband may be flexible enough to permit the user to aim the material by changing the position of dispenser 104 relative to the wristband. In other embodiments, a connection may be provided between the band and the dispenser which permits the user to aim the material. For example, the connection may permit the user to rotate the dispenser on the band.

Details of Dispenser 104

### FIRST EMBODIMENT

### FIG. 2

FIG. 2 is a detailed drawing 201 of a first embodiment of dispenser 104. The main components of drawing 201 are views 203 of pump 105, including a detailed top view 204, a cutaway side view 216, and a rear view 206. Three-dimensional views of dispenser 104 are shown at 222. In these views, corresponding elements have the same reference numbers. In one embodiment, dispenser 101 is of the disposable type. The material being dispensed is contained in a gel bag 223 in a compartment 221 in pump 105. In disposable embodiments of dispenser 101, the gel bag is placed in compartment 221 when dispenser 101 is manufactured; in refillable embodiments, a user may purchase a gel bag of the material separately and place it in compartment 221. In such an embodiment, access may be gained to compartment 221 by removing front cap 205.

Beginning with top view 204, one embodiment of pump 105 has a front cap 205. Included in front cap 205 is a one-way spit valve 215. One-way spit valve 215 allows a blob of material to leave pump 105, but will not permit air to enter pump 105. Pump housing 207 includes a tube 217 in which a piston 209 moves and guide rails 211 for piston 209. A one-way air valve 213 permits air to enter tube 217 but not to leave tube 217. Piston 209 moves forward 25 in tube 217 when pressed by a user of dispenser 101. It should be noted that portion 212 of piston 209 covers the opening of one-way air valve 213 during a portion of the travel of piston 209 in tube 217.

Continuing with side view 216, piston 209 works against spring 210. The user pushes piston 209 in against the spring and spring 210 pushes the piston back to its former position. Piston 209 works on both its back and forward strokes. On the back stroke, it sucks material from gel bag 223 and on the forward stroke, it forces the material out of pump 205 via nozzle 215. Operation of the pump involves in addition to piston 209 and tube 217, one way air valve 213, one way spit valve 215, one way valve 225, and chambers 219 and 221.
chamber 221 contains gel bag 223 and is always at the ambient air pressure;
An end of tube 217 and chamber 219 are interconnected by opening 218. Pressure in chamber 219 is determined by the motion of piston 209 in tube 217 and piston 209's interaction with one-way air valve 213.

The operational cycle of pump 105 is as follows:

1. The first stroke is a priming stroke. At the beginning of operation, piston 209 is in its back position in tube 217, chamber 219 is at atmospheric pressure, and the level of the material being dispensed is below one way spit valve 215 in chamber 219. When the user pushes piston 209 forward in tube 217, the air pressure in chamber 219 rises and the pressure forces open one way spit valve 215.

2. At the end of the forward stroke, spring 210 forces piston 209 back. There are two parts of the back stroke: a first part in which one way air valve 213 is covered by portion 212 of piston 209 and a second part in which one way air valve 213 is not covered by portion 212.
a) Because air valve 213 is covered during the first part of the back stroke, a vacuum develops in chamber 219. In response to the vacuum, one-way spit valve 215 remains closed and the ambient air pressure of chamber 221 works on gel bag 223 to force the contents of the material out into chamber 219. The dimensions of tube 217 and chamber 219 and the location of one-way air valve 213 in tube 217 are chosen such that the amount of material forced out fills most of chamber 219.
b) During the second part, one way air valve 213 is uncovered, so that tube 217 fills with air at atmospheric pressure.

3. On the next forward stroke, one way air valve 213 prevents the air in chamber 217 from leaving the chamber, so the compressed air finds its way via opening 218 into chamber 219, where it forces the material which was drawn into the chamber during the first part of the preceding back stroke out of one-way spit valve 215. The amount of material forced out depends on the size of chamber 217, the location of one way spit valve 215 in the chamber, and the length of the stroke of the piston after the one-way valve.

On the next back stroke, chamber 219 will again fill with the material and tube 217 with air as just described, and the cycle will continue.

One way valves 213 and 225 are standard items in the relevant technologies. The one-way spit valve 215 is an adaptation of the anti-drip valves used on catsup bottles. These anti-drip valves are silicon membranes which contain a slit that opens when the membrane bulges in response to a pressure difference on its two sides and closes again when the pressure difference ends. Because the anti-drip valve closes automatically, the catsup leaves the bottle in a burst, instead of dribbling out. For the same reason, when the material is forced out of chamber 219, it comes out in a burst, instead of dribbling out.

The problem with using an anti-drip valve like the ones on catsup bottles for spit valve 215 is 5 that when the air pressure in the catsup bottle is less than the atmospheric pressure, the anti-drip valve also opens to permit air to enter the catsup bottle. While this is desirable in catsup bottles, one-way spit valve 215 must not open when there is a vacuum in chamber 219. The one way action of valve 215 is achieved by means of support 220, which prevents spit valve 221 from bulging and therefore opening to admit air when there is a vacuum in chamber 219 but does not completely block the contents of chamber 219 from reaching spit valve 215. Thus, when the pressure in chamber 215 is higher than atmospheric pressure, air or material contained in chamber 219 can exit via one way spit valve 215, but when there is a vacuum in chamber 219, the one way spit valve remains sealed.

### SECOND EMBODIMENT

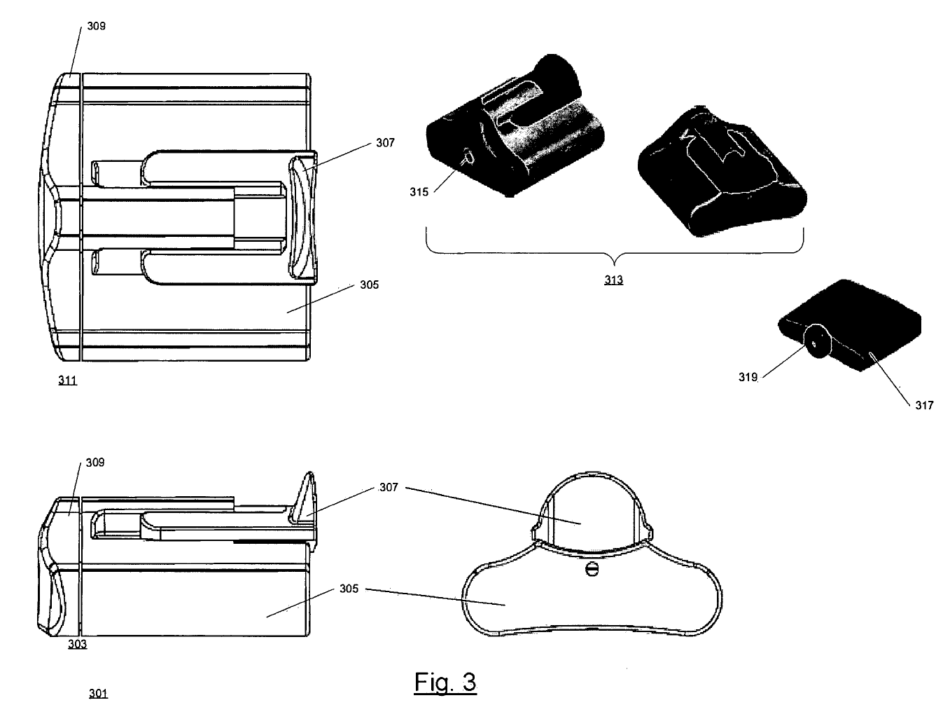

### FIGS. 3-5

FIG. 3 shows various views of a second embodiment 301 of dispenser 104. Dispenser 301 operates according to the same general principles as first embodiment 201, At 303 is shown a side view, at 311 is shown a top view, and at 313 is shown an end view. Three-dimensional views from the front and rear are shown at 313; gel bag 317 containing the material to be dispensed has one-way valve 319. Components of dispenser 301 that are of interest in the present context are housing 305, front cap 309, piston 307, and nozzle 315. In dispenser 301, front cap 309 is removable, permitting replacement of gel bag 317.

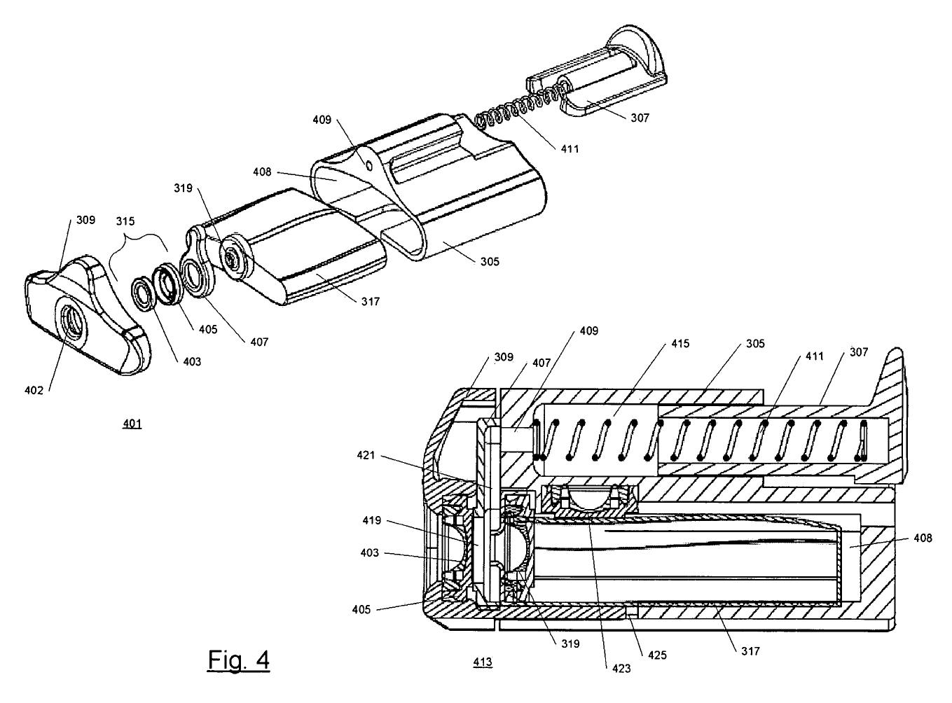

FIG. 4 shows an exploded view 401 and a cross-sectional view 413 of dispenser 301. Beginning at the left of exploded view 401 there are seen front cap 309 with a hole 402 for nozzle 315, and nozzle 315, which has two components: spit valve 403 with support 405 which prevents spit valve 403 from flexing to the right. Material chamber 407 is connected by a passage to the tube in which piston 307 moves and has a cavity which fills with material from gel bag 317 when piston 307 moves back. Then come gel bag 317 with one-way valve 319, housing 305 with 30 chamber 408 for gel bag 317 and hole 409 belonging to the passage connecting the tube with material chamber 407, spring 411 for piston 307, and finally the piston itself.

Cross-sectional view 401 additionally shows cavity 419 in material chamber 407 and passage 421 which connects cavity 419 to hole 409. Hole 409 is in turn connected to tube 415 in which piston 307 moves. One-way valve 423 connects tube 415 to chamber 408 for gel bag 317. A passage 425 ensures that chamber 408 remains at atmospheric pressure. Dispenser 301 operates in exactly the same fashion as dispenser 201. Advantages of dispenser 301 include the following:

1. The location of one-way air valve 423 so that it opens onto cavity 408 reduces the overall height of dispenser 301 and protects air valve 423;

2. Material Chamber 419 has been designed to minimize the formation of pockets of air in the material that is drawn into chamber 419 from gel bag 317, Such pockets keep the blast of air produced when the piston is moved towards the end of tube 415 from pushing out all of the material in chamber 419. Maximizing the force of the air blast is particularly important with higher-viscosity materials.

3. The spit valve has been relocated so that it is in line with the nozzle 318 of the gel bag. The new location also prevents pockets of air from forming in the material in chamber 419.

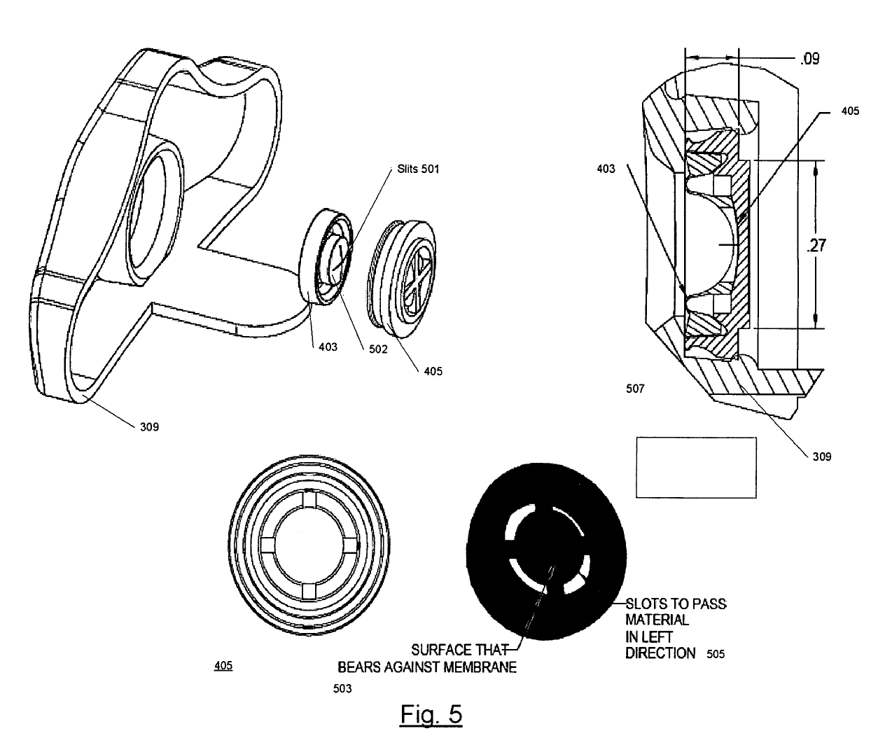

Details of One-Way Spit Valve 315: FIG. 5

One-way Spit valve 315 incorporates a silicon valve 403 of a type that is manufactured under the name SimpliSqueeze® by Seaquist Closures, 711 Fox St., Mukwonago, Wis. 53149. As shown at 403 in FIG. 5, valve 403 is a silicon diaphragm 502 with slits 501. When a pressure difference between the sides of diaphragm 502 causes diaphragm 502 to bulge towards the side with lower pressure, the flaps defined by the slits 501 roll back and material can pass through the part of the diaphragm between the slits. Silicon valves like valve 403 are typically used in applications like catsup bottles. When the catsup bottle is squeezed, the valve bulges outward and opens, a blob of catsup comes out, the valve ceases to bulge out and closes, and then bulges in and opens again to admit air to the catsup bottle. Once the pressure on both sides of the valve is equal, the valve ceases bulging and closes.

When silicon valve 403 is used in one-way spit valve 315, it must bulge out and open when the pressure in chamber 419 is greater than the atmospheric pressure, but remain closed when the pressure in chamber 419 is less than atmospheric pressure. The valve will remain closed if it is not permitted to bulge in when the pressure in chamber 419 is less than atmospheric pressure. To prevent valve 403 from bulging in, one embodiment employs support 405. Support 405 has slots 505 to permit the material in chamber 419 to pass through support 405 when valve 35 403 is open and surface 503 that bears against diaphragm 402 and prevents valve 403 from bulging in and opening when chamber 419 is at less than atmospheric pressure. At 507 is shown a detailed cross section of front cap 309 with components 403 and 405 of one-way spit valve 315 installed in it.

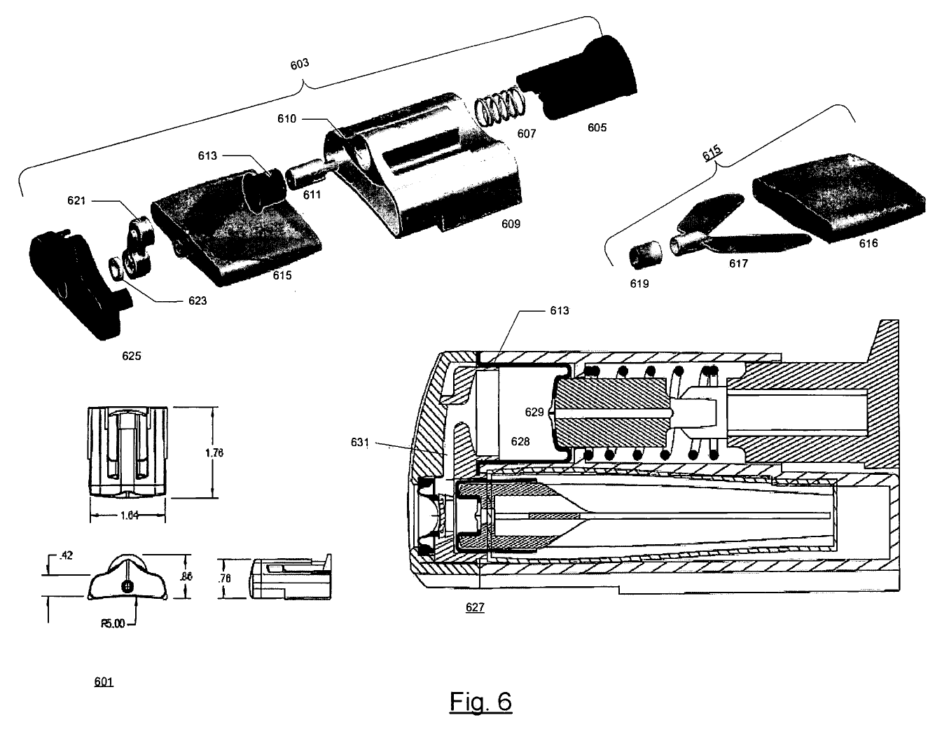

The First Improved Version: FIG. 6

FIG. 6 shows at 601 views of an implementation of the dispenser of the wrist-mounted dispenser which is closely related to the dispenser shown in FIG. 4 of WO2007035366. Beginning at the left of exploded view 603 there are seen front cap 625 with a hole for nozzle 623, and nozzle 623 at the front end of the dispenser. The nozzle 623 has two components: a spit valve and a support which prevents the spit valve from flexing to the right. As shown in exploded view 615, material chamber includes chamber 616 itself, a gel bag 616 which contains the material being dispensed and is at atmospheric pressure. At the end of chamber 616 is a one-way valve 619 which permits the contents of the gel bag to flow out, but bars air from flowing in. A substantially air-tight passage in piece 621 connects the end of cylinder 610 with one-way valve 619 and nozzle 623. Then come housing 609 with a chamber for material chamber 615, spring 607 for piston 611, and finally piston actuator 605. When a user pushes on activator 605, piston 611 moves toward cap 625; when the user ceases pushing on activator 605, spring 607 returns piston 611 in the opposite direction. In one embodiment, a user of wrist-mounted dispenser 601 may be able to buy a replacement material chamber 615 with a new gel bag 617 and valve 619 and load it into housing 609.

Cross-sectional view 627 additionally shows the following:
passage 631, the passage which connects cylinder 610, the one-way valve belonging to the gel bag, and nozzle 623;
flexible seal 613, which moves with piston 611; and
weep hole 629, which admits a predetermined amount of air into the volume 628 sealed by seal 613 when the piston moves backward.

A passage in housing 609 ensures that gel bag 617 is always subject to atmospheric pressure. Dispenser 601 operates as follows:

1. The first stroke is a priming stroke. At the beginning of operation, piston 611 is in its back position in tube 610, passage 631 is at atmospheric pressure, and the level of the material being dispensed is below the spit valve in nozzle 623. When the user pushes piston 611 forward in tube 610, the piston 611 moves toward the front end of the dispenser, and the air pressure in passage 631 rises and the pressure forces the one way spit valve open.

2. At the end of the forward stroke, spring 607 forces piston 611 back away from the front end of the dispenser. Because of seal 613, the backward motion of piston 611 creates a vacuum in passage 631. In response to the vacuum, the one-way spit valve in nozzle 623 remains closed and the ambient air pressure works on gel bag 617 to force the contents of the material out into passage 631 and into the volume 628 sealed by seal 613. Leakage of air through weep hole 629 ensures that some air remains in volume 628 between the material and the end of piston 611.

3. On the next forward stroke, the material and the air in volume 628 find their way into passage 631 and out of the one-way spit valve. The air follows the material and provides a blast of compressed air which cleans any remaining material out of passage 631. The amount of material forced out of the one-way spit valve depends on the dimensions of volume 628, the size of passage 632, and the amount of air which enters via weep hole 628.

On the next back stroke, passage 631 will fill with material and volume 628 will fill with the material and air as just described, and the cycle will continue.

The use of the weep hole to ensure that volume 628 includes air as well as the material is particularly effective when the material has a low viscosity. When the material is of low viscosity and volume 628 includes air, a one-way valve other than a spit valve may be employed in nozzle 623.

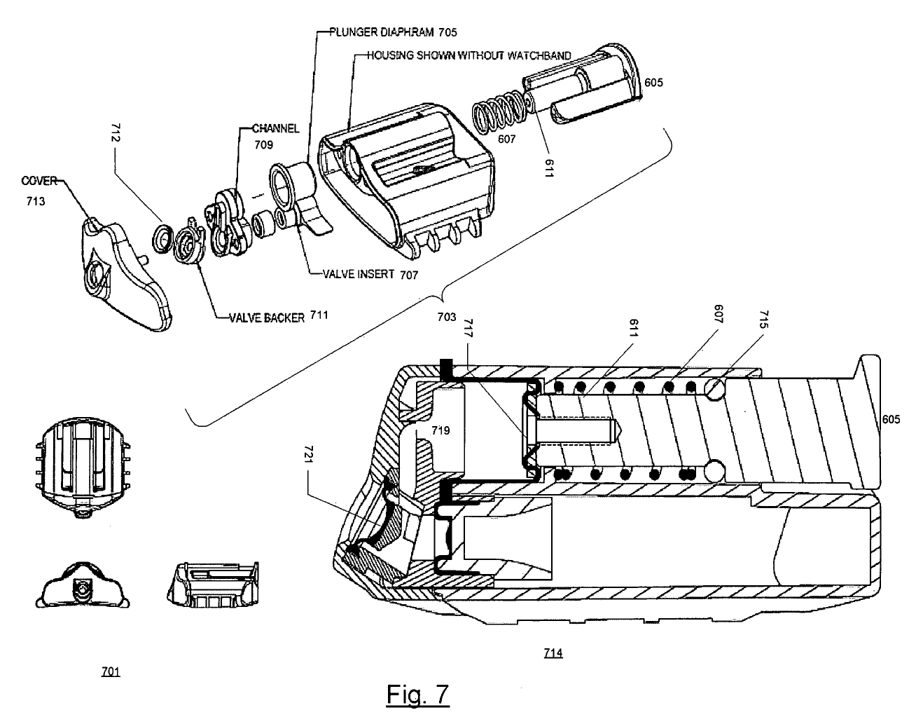

The Second Improved Version: FIG. 7

Experience with the improved version of FIG. 6 has shown that when the material being dispensed has a high viscosity, the presence of air in volume 628 impairs the performance of the dispenser. FIG. 7 shows a version 701 of the dispenser which differs in two important respects from the version of FIG. 6: the piston of the pump does not include a weep hole 629, as shown at 717; further, spit valve 712 is tilted as shown at 721 so that the material being dispensed lands on the palm of the hand belonging to the wrist on which the dispenser is worn. The spit valve is tilted in relation to a direction of movement of the piston. Alternatively, the spit valve exit is located in-line with the piston. At 703 is shown an exploded view which includes piston diaphragm 705, valve insert 707, channel 709, valve backer 711, spit valve 712, and cover 713. As shown in cross section 714, there is no weep hole at 717. Also included in the piston is an O ring 715 which serves as a seal between the piston and the cylinder in which it moves. After the piston has completed its backstroke, volume 628 and passage 631 are substantially filled with the material being dispensed. On the return stroke, the piston thus works directly on the substance being dispensed. Since the substance is not compressible, the behavior of the dispenser when the piston works directly on the substance is far more predictable than when it works on air, which then works on the substance. An advantage of spit valve 712 is that no blast of air is needed to expel the material through the valve. Further, the spit valve 712 is sufficient to cut-off the stream of material. The air-blast follow-up in the first improved version is thus not necessary with the second improved version. Cutting-off the stream of material prevents spillage of the material onto the wrist and ensures that the material is emitted onto the palm or fingers. The pump of the second improved version is a closed system that minimizes the introduction of air into the chamber. This prevents the material from settling below the air and changing the pumping characteristics. The pump of the second improved version thus functions regardless of the direction of gravitational pull.

Advantages of Improved Versions 601 and 701

In improved versions 601 and 701, the amount of material dispensed when the piston is moved forward depends on the sizes of volume 628 and passage 631, the position of the spit valve in passage 631, and the size of any weep hole. Versions 601 and 701 thus automatically dispense measured amounts of the material. The improved versions are also leak-free. The use of plunger diaphragm 613 or 705 prevents the substance from leaking around piston 611. With high-viscosity substances, the use of the spit valve prevents the material from escaping from passage 631 except when under pressure by piston 611. With low-viscosity substances, the air which enters volume 608 via weep hole 629 ensures that all of the substance is blown out of passage 631 when the piston is moved forward and thereby prevents leakage through nozzle 623.

Important Design Principles of Improved Versions 601 and 701

1. The length of passage 631 should be minimized;

2. Passage 631 should be designed to minimize the development of eddies in the substance as it flows through the passage. For example, the exit 719 from volume 628 to the passage should be chamfered.

3. The surface area of the path from gel bag 617 through the one-way valve by which the material enters passage 631 should be minimized.

4. The amount of material delivered when piston 611 is moved forward is determined by the size of volume 628 and the length and size of passage 631 between exit hole 619 and the spit valve. In the case of version 601 the amount of material delivered is further determined by the size of weep hole 628.

5. Diaphragm 613 or 705 should be attached to a washer on the end of piston 611 to prevent the diaphragm from collapsing on the back stroke of piston 611.

6. The behavior of the spit valve depends on the diameter of the spit valve, the thickness of the material from which the spit valve is made, and the length of the slit in the material.

It should be noted here that the valve through which material exits from passage 631 may be at any position along the passage.

Details of Version 701

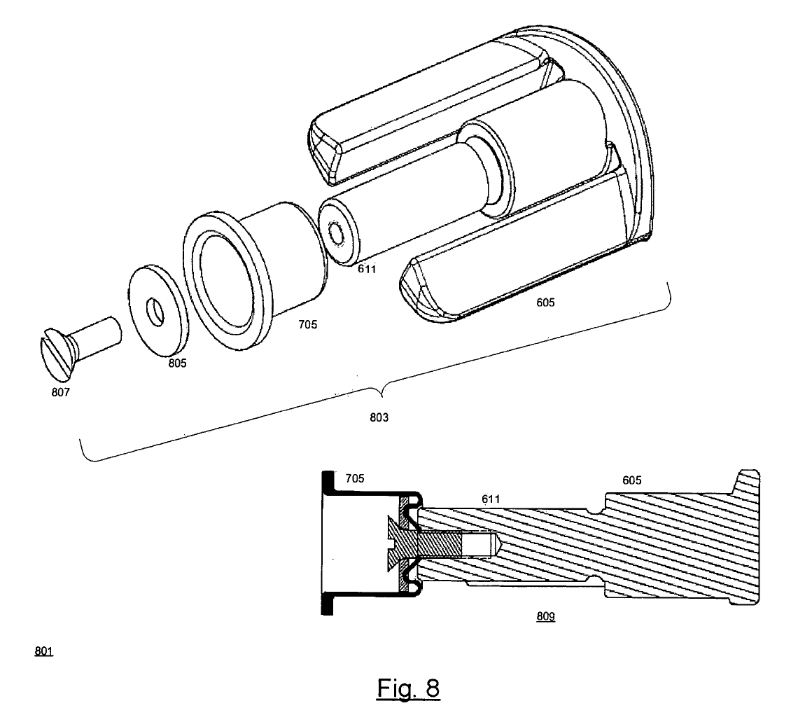

FIG. 8 shows details of the plunger in one environment. Shown in exploded view 803 are plunger actuator 605, plunger 611, plunger diaphragm, 705, washer 805 which prevents collapse of diaphragm 705 on the reverse stroke, and screw 807, which secures washer 805 and diaphragm 705 to plunger 611. The same elements are shown in cross section 809 of an assembled plunger and plunger actuator.

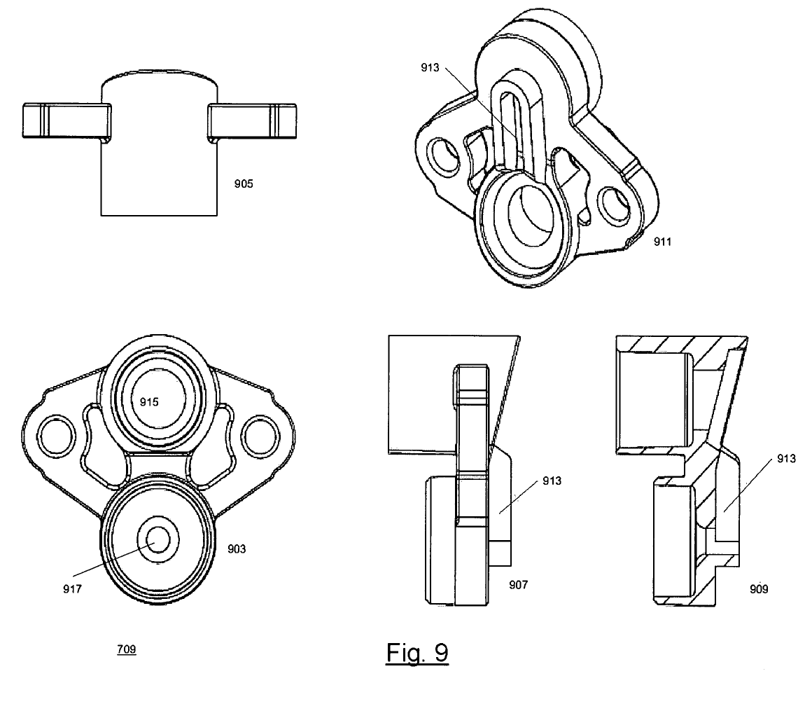

FIG. 9 shows details of channel piece 709, which contains passage 631 connecting volume 628, the spit valve, and the one-way valve of gel bag 617. At 903, 905, and 907 are shown an orthographic projection of channel piece 709 as seen from the side away from cover 713. Hole 917 is the chamfered hole which connects passage 631 to volume 628 and hole 915 is the hole which connects passage 631 to the spit valve and to the one-way valve of gel bag 617. At 911 is shown an isometric projection of channel piece 709 as seen from the side towards cover 713. Hole 915 is at the bottom of projection 911. Passage 631 is shown at 913 in views 911, 907, and 909.

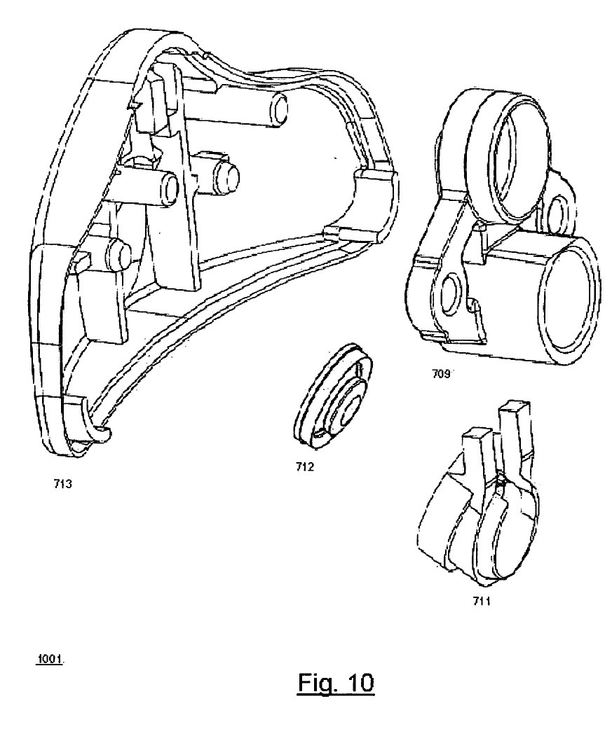

FIG. 10 shows details 1001 of the manner in which channel piece 709, valve backer 711, and spit valve 712 are assembled together and then assembled to cover 713, which is seen from the rear. When the pieces are assembled, cover 713 provides the fourth side of passage 631.

### CONCLUSION

The foregoing Detailed Description has disclosed to those skilled in the relevant technologies how to make and use apparatus for dispensing material that includes a dispenser comprising a pump and a one-way valve employed in an embodiment of the dispenser and has further disclosed the best mode known to the inventors of making and using the apparatus for dispensing material, the pump, and the one-way valve. It will, however, be immediately apparent to those skilled in the relevant technologies that apparatus for dispensing material, pumps, or one-way valves that operate according to the principles disclosed herein may be made that differ in many ways from the embodiments disclosed herein. For example, the dispenser may use any available technique for transferring the material from the dispenser's reservoir to the users palm or fingers when the user presses the activator, the material may be any material which can be usefully dispensed in that fashion. Pumps made according to the principles of the pump disclosed herein may be of any size and may have many different arrangements of their components relative to each other. Similarly, the diaphragm of the one-way valve disclosed herein may be made of any material which has the necessary properties as regards flexing and opening when it is flexed and the support may be implemented in any way which permits the diaphragm to flex in one direction and prevents the diaphragm from flexing in the other. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

We claim:

1. Apparatus for dispensing material, comprising:
a chamber for the material, the chamber sealed by a flexible seal;
a nozzle coupled to the chamber and residing at a front end; and
a pump, the pump comprising:
a piston that moves in a tube, and
an activator,
the pump responding to pressure of a finger on the activator by emitting a portion of the material in the space through the nozzle, wherein the piston moves toward or away from the front end, wherein the pump emits the portion of the material regardless of a direction of gravitational pull.

2. The apparatus of claim 1, wherein the dispenser further comprises:
a weep hole traversing the flexible seal, wherein the pump responds to pressure of the finger on the piston by admitting a predetermined amount of air through the weep hole into the chamber and emits the portion of the material in the chamber through the nozzle using the predetermined amount of air.

3. The apparatus of claim 2, wherein the predetermined amount of air resides in the chamber between the material and the piston.

4. The apparatus of claim 3, wherein the predetermined amount of air provides compressed air used to emit the portion of the material in the chamber.

5. The apparatus of claim 1, wherein the dispenser responds to the pressure of the finger on the activator by creating a vacuum in the chamber and emitting the portion of the material in the chamber through the nozzle by direct contact between the piston and the material.

6. The apparatus of claim 1, wherein the dispenser comprises a direction of movement of the piston toward or away from the front end, wherein the nozzle is titled in relation to the direction of movement.

7. The apparatus of claim 1, further comprising:
a bracelet worn on a wrist of a user, such that the apparatus is on a palm side of the wrist,
wherein the nozzle is situated on the front end such that the emitted material is directed towards a palm or fingers of a hand attached to the wrist.

8. The apparatus of claim 7, wherein:
the bracelet is flexible; and
the emission of the material is aimed by flexing the bracelet.

9. The apparatus of claim 1, wherein:
the chamber may be refilled with the material.

10. The apparatus of claim 1, wherein the pump further comprises a spring, wherein when the spring is in an uncompressed state, the piston is urged away from the front end.

11. Apparatus for dispensing material, comprising:
a chamber for the material, the chamber sealed by a flexible seal;
a nozzle coupled to the chamber and residing at a front end; and
a pump, the pump comprising an activator,
the pump responding to pressure of finger on the activator by creating a vacuum in the chamber and emitting a portion of the material in the chamber through the nozzle by direct contact between the activator and the material.

12. Apparatus for dispensing material comprising:
a chamber for the material, the chamber sealed by a flexible seal;
a weep hole traversing the flexible seal;
a nozzle coupled to the chamber; and
a pump, the pump comprising an activator,
the pump responding to pressure of a finger on the activator by admitting a predetermined amount of air through the weep hole into the space chamber and emitting a portion of the material in the chamber through the nozzle using the predetermined amount of air.
